(19) United States
(12) Patent Application Publication
(10) Pub. No.: US 2007/0094495 A1
(43) Pub. Date: Apr. 26, 2007

(54) Statically Verifiable Inter-Process-Communicative Isolated Processes

(75) Inventors: Galen C. Hunt, Bellevue, WA (US); James R. Larus, Mercer Island, WA (US); Martin Abadi, Palo Alto, CA (US); Mark Aiken, Seattle, WA (US); Paul Barham, Cambridge (GB); Manuel Fahndrich, Seattle, WA (US); Chris K. Hawblitzel, Redmond, WA (US); Orion Hodson, Redmond, WA (US); Steven P. Levi, Redmond, WA (US); Nicholas Murphy, San Mateo, CA (US); Bjarne Steensgaard, Redmond, WA (US); David R. Tarditi, Kirkland, WA (US); Edward P. Wobber, Menlo Park, CA (US); Brian Zill, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/428,162

(22) Filed: Jun. 30, 2006

Related U.S. Application Data
(60) Provisional application No. 60/730,546, filed on Oct. 26, 2005.

(51) Int. Cl. H04L 9/00

(52) U.S. Cl. 713/157

(57) ABSTRACT

Described herein are one or more implementations of an operating system that provides for statically verifiable inter-process communication between isolated processes. Also, described herein are one or more implementations of programming tools that facilitate the development of statically verifiable isolated processes having inter-process communication.

### RELATED APPLICATIONS

This application claims priority to U.S. Patent Provisional Application Ser. No. 60/730,546, filed Oct. 26, 2005, the disclosure of which is incorporated by reference herein.

### BACKGROUND

Some operating systems (OSs) provide process isolation and inter-process communication. OSs attempt to isolate a process so that it cannot access or corrupt data or executing instructions of another process. In addition, isolation provides clear boundaries for shutting down a process and reclaiming its resources without cooperation from other processes. Inter-process communication allows processes to exchange data and signal events.

However, there is a natural tension between isolation and communication amongst processes. Typically, the more isolated processes are from each other, the more complicated and potentially expensive it may be for processes to communicate with each other. Conversely, the less isolated processes are from each other, the easier it is for processes to communicate with one another.

For example, processes that share memory may be considered to have a low degree of isolation. Shared-memory processes typically can communicate in an apparently simple way just by writing and reading directly to/from shared memory. If, on the other hand, an OS does not allow processes to share memory, the OS typically provides some mechanism for processes to exchange information.

In deference to performance considerations, the tradeoffs between isolation and communication are conventionally resolved in a manner that sacrifices the benefits of isolation. In particular, conventional OSs often allow shared memory amongst processes. So, OSs even co-locate components within the same process to maximize communication. Examples of such co-location are device drivers, browser extensions, and web-service plug-ins. Eschewing process isolation for such case of access to such components may complicate or destroy many of the benefits of isolationism, such as failure isolation and clear resource management. When one component fails, that failure often leaves shared memory in an inconsistent or corrupted state that may render the remaining components inoperable.

At the other end of the spectrum, truly isolated processes, of course, enjoy the benefits of isolationism. However, such isolated processes conventionally struggle with inter-process communication.

### SUMMARY

Described herein are one or more implementations of an operating system that provides for statically verifiable inter-process communication between isolated processes. Also, described herein are one or more implementations of programming tools that facilitate the development of statically verifiable isolated processes having inter-process communication.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The same numbers are used throughout the drawings to reference like elements and features.

FIG. 1 is an operational scenario for an operating system architecture that supports one or more implementations described herein.

FIG. 2 is another operational scenario for an operating system architecture that supports one or more implementations described herein.

FIG. 3 is a block diagram an operating system architecture that supports one or more implementations described herein.

FIG. 4 is flowchart of another methodological implementation described herein.

FIG. 5 is flowchart of another methodological implementation described herein.

### DETAILED DESCRIPTION

The following description sets forth an operating system (OS) that provides for isolated processes having capability for inter-process communication. The isolation of the isolated processes of the described OS between is statically verifiable. The executable instructions of the isolated process may be verified at compile time or run time or both. Also, described herein, are one or more programming language tools that facilitate development of statically verifiable inter-process communication between isolated processes.

A statically verifiable process is a software process whose executable instructions can be analyzed without actually executing the process' instructions. The analysis ensures that the process will not behave in disallowed ways and/or interfere with operation of other processes or the operating system itself.

One or more implementations described herein employ programming language tools to create an environment in which software is more likely to be built better, program behavior is easier to verify, and run-time failures can be contained and alleviated. Some of the features of the one or more implementations described herein include (but are not limited to):
Data is exchanged over bidirectional channels, where each channel consists of exactly two endpoints. At any moment in time, each channel endpoint is owned by a single thread (i.e., owed by a single process).
Buffers and other memory data structures are transferred by pointer, rather than by copying the data contained in the buffers and memory data structures. These transfers pass ownership of blocks of memory.
Channel communication is governed by statically verifiable channel contracts that describe messages, message argument types, and valid message interaction sequences as finite state machines similar to session types.
Channel endpoints can be sent in messages over channels. Thus, the communication network may evolve dynamically.
Sending and receiving on a channel requires no memory allocation.
Sends are non-blocking and non-failing. Non-blocking means that the sending does not wait for communication to succeed. Non-failing means that communication always succeeds eventually. The implementation achieves this by definition: a sending operation completes without waiting for results. (However, that a “channel” can fail and this can be observed when receiving on the channel.)

The following co-pending patent applications (which are commonly owned by the same assignee as this application) are incorporated herein by reference:
U.S. patent application Ser. No. 11/005,562, which was filed on Dec. 6, 2004 and is titled “Operating-System Process Construction.” Herein, it called the “Operating-System Process Construction.” This application provides details on the creation of isolated processes.
U.S. patent application Ser. No. 11/007,655, which was filed on Dec. 7, 2004 and is titled “Inter-Process Communications Employing Bi-directional Message Conduits.” Herein, it called the “Inter-Process Communications Employing Bi-directional Message Conduits.” This application provides details regarding inter-process communication between isolated processes.
U.S. patent application Ser. No. 11/007,808, which was filed on Dec. 7, 2004 and is titled “Self-Describing Artifacts and Application Abstractions.” Herein, it called the “Self-Describing Artifacts and Application Abstractions.” This application provides details regarding creation of an application, which includes one or more processes.
   Exemplary Operating System and Programming Tools

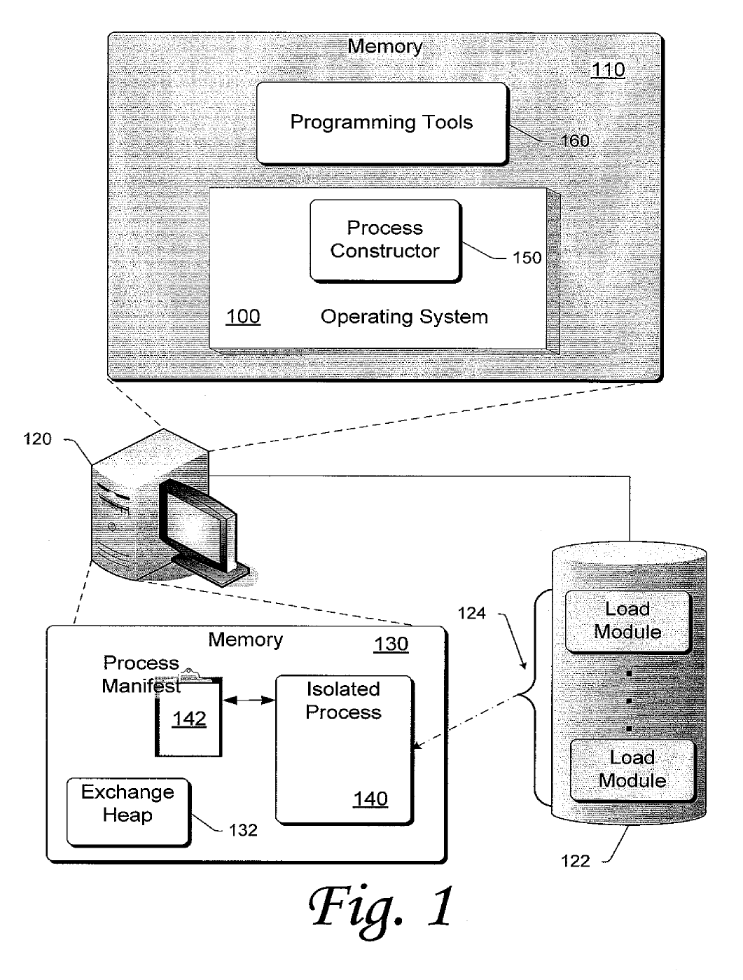

FIG. 1 shows an exemplary operational scenario that supports statically verifiable inter-process communicative Software-Isolated Processes (SIPs) and the use of programming tools which facilitate the programming of such statically verifiable inter-process communicative SIPs.

FIG. 1 shows an operating system 100 and programming tools 160 stored and/or executing in a memory 110 of a computer 120. The computer 120 typically includes a variety of processor-readable media (including the memory 110). Such media may be any available media that is accessible by the computer 120 and includes both volatile and non-volatile media, removable and non-removable media.

Computer 120 includes a computer storage device 122 (e.g., hard drive, RAID system, etc.) that stores a set of load modules 124 and a working memory 130 (which may be part of or separate from the memory 110).

The working memory 130 also includes an exchange heap 132, which is a buffer used to hold information (such as pointers to locations in the working memory 130). Herein, the exchange heap may be called a “buffer,” a “shared exchange buffer,” or something equivalent thereto. The heap include multiple addressable memory blocks (as shown by blocks 134). Although the exchange heap 132 as a whole is accessible by multiple processes, each individual block is owned by one process at a time (when that block is in use). However, ownership of a memory block may be exchanged with another active process. So, in this way, the exchange heap 132 provides a mechanism for SIPs to exchange data.

As depicted, the operating system 100 comprises a process constructor 150 module. The process constructor may be part of the kernel of the operating system 100. The process constructor 150 constructs processes in a computer's working memory from a dynamic set of constituent components, which is typically manifested as a set of load modules stored in computer storage.

In the example in FIG. 1, the process constructor 150 constructs a process 140 which is stored in the working memory 130. As depicted here, the process 140 is constructed from load modules 124, which are manifestations of the process's constituent components edited by the process's extending components.

The process 140 has a process manifest 142, which defines the contents of the process 140, the permitted behavior of the process, and other possible properties of the process. As depicted here, the process manifest 142 is directly associated with a process (such as process 140) whose composition it describes.

The programming tools 160 comprises modules and data structures. With these, the programming tools 160 helps the person who develops the process in the creation of a static variable and isolated process with defined and restricted inter-process communication of process. The programming tools 160 facilitates this development by using imposing strong invariants that are enforced at compile time, run time, or both. Strong invariants are discussed below in the “Verification” section.

The programming tools 160 provide static analysis tools to help programmers find, correct, and/or prevent inter-process communication errors without time-consuming testing and debugging. By increasing the effectiveness and applicability of deterministic static pre-computation analysis tools, the programming tools 160 further increase the likelihood that a programmer or set of programmers will produce a program or set of programs that are free of inter-process communication-related errors, and further reduces the testing and debugging effort required to produce such a program or set of programs.

The described programming tools (e.g., the programming tools 160 of FIG. 1) employ programming constructs and approaches that facilitate a developer's use and creation of SIPs (as described herein). With the described programming tools, SIP communication may be statically verified.

Software Isolated Process

In the realm of computer science and, more particularly, the art of operating systems, the term “software process” (or more simply, “process”) is well-known. Applications are often composed of one or more processes. The operating system (OS) is aware of and, indeed, may manage and supervise one or more separate processes running on a computer.

One or more implementations are described herein to operate in an OS model which provides for and/or supports a Software-Isolated Process (SIP) abstraction model. SIPs encapsulate pieces of a program or a system and provide information hiding, failure isolation, and strong interfaces. SIPs are used throughout an OS and application software in accordance with the described implementations.

With SIPs, the executable code outside the kernel executes in a SIP and communicates through strongly typed communication channels. A SIP is a closed environment, which does not allow data sharing or dynamic code loading. SIPs differ from conventional OS processes in a number of ways. The following are examples of such ways the SIPs different from conventional OS processes:
SIPs are closed object spaces, not address spaces. Two SIPs cannot simultaneously access an object. Communications between processes transfers exclusive ownership of data.
SIPs are also closed code spaces. A process does not dynamically load or generate code.
SIPs do not rely on memory management hardware for isolation, so multiple SIPs can reside in a physical or virtual address space.
Communications between SIPs is through bidirectional, strongly typed, higher-order channels. A channel's type describes its communications protocol as well as the values it transfers, and both aspects are verified.
SIPs are inexpensive to create and communication between SIPs incurs low overhead. Their low costs make it practical to use SIPs as a fine-grain isolation and extension mechanism.
SIPs are created and managed by the operating system, so that on termination, a SIP's resources can be efficiently reclaimed.
SIPs are independent execution environments, even to the extent of having different data layouts, run-time systems, and garbage collectors. Other safe language systems support one execution environment.

The term “software isolation processes” or “SIPs” is used herein for convenience. It is not intended to limit the scope of this concept. Indeed, this concept can be implemented in software, hardware, firmware, or a combination thereof.

Inter-Process Communication

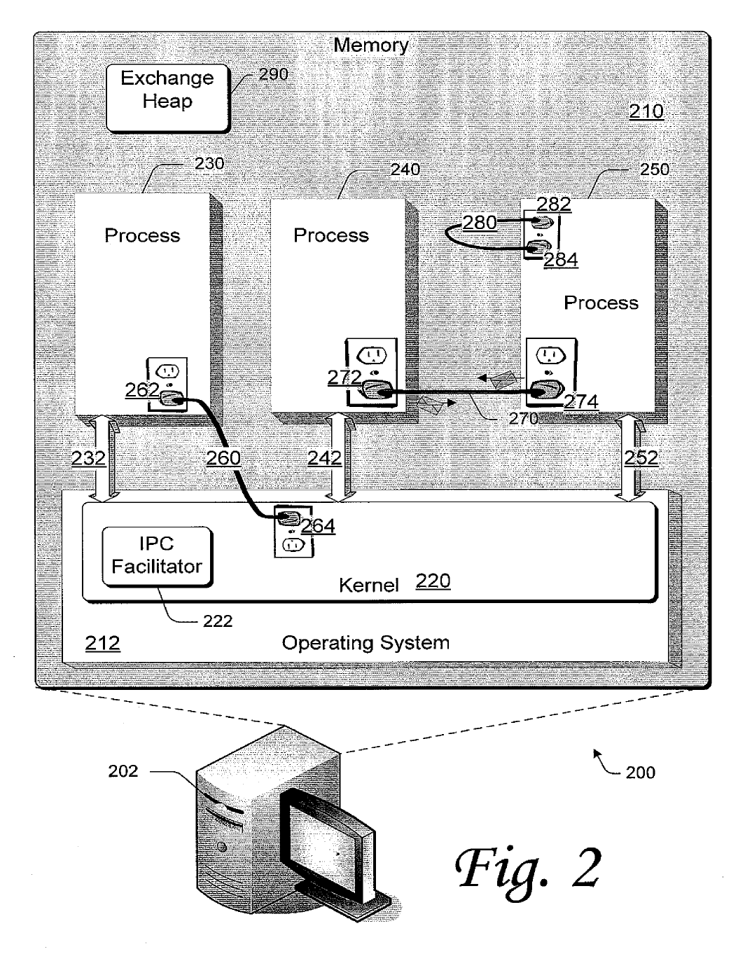

FIG. 2 illustrates an exemplary inter-process communication (IPC) architecture 200 that facilities inter-process communication without unanticipated interactions between SIPs. In addition to providing for communication between processes, the exemplary IPC architecture 200 may provides for communication between processes and an operating system's kernel.

With the exemplary IPC architecture 200, SIPs communicate exclusively by sending messages over channels, which are a bidirectional, behaviorally typed connection between two processes. Messages are tagged collections of values or message blocks in an “Exchange Heap” (such as the exchange heap 132 of FIG. 1 above) that are transferred from a sending to a receiving process. A channel is typed by a contract, which specifies the format of messages and valid messages sequences along the channel.

As depicted in FIG. 2, the exemplary JPC architecture 200 is implemented on a computer 202, which is configured with a memory 210 (e.g., volatile, non-volatile, removable, non-removable, etc.). An operating system (OS) 212 is shown stored in the memory 210 and is executed on the computer 202.

OS 212 has a kernel 220. The OS kernel 220 incorporates an Inter-Process Communication (IPC) facilitator 222. The OS kernel 220 may construct one or more processes. FIG. 2 shows, for example, three active process (230, 240, and 250) running in memory 210.

The IPC facilitator 222 facilitates communications amongst active processes (such as processes 230, 240, and 250). While FIG. 2 illustrates the OS kernel 220 implementing the IPC facilitator 222, other implementations may have the IPC facilitator that is external to the OS kernel. If so, each would work in cooperation and/or coordination with the OS.

The memory 210 also includes an exchange heap 290, which has multiple memory blocks 292. The exchange heap 290 is accessible by multiple active processes (such as processes 230, 240, and 250). It provides a mechanism for SIPs to exchange data.

The “Inter-Process Communications Employing Bi-directional Message Conduits” (referenced above) discloses additional details regarding an exemplary IPC architecture 200, which is suitable for one or more implementations described herein.

The Exchange Heap

Each SIP maintains its own independent and private heaps. SIPs do not share memory with each other. So, when data is passed from one SIP to another SIP, that passed data does not come from a process' private heap. Instead, it comes from a separate heap is used to hold data that can move between processes. That separate heap is the exchange heap, such as the exchange heap 132 shown in FIG. 1 or the exchange heap 290 shown in FIG. 2.

SIPs may contain pointers into their own private heap. In addition, SIPs may contain pointers into the public exchange heap. In at least one described implementation, the exchange heap only contains pointers into the exchange heap itself. Each SIPs may hold multiple pointers into the exchange heap. However, each block of memory in the exchange heap is owned (i.e., accessible) by-at most-one SIP at any moment during the execution of the system.

When performing static verification, the programming tools 160 may track the ownership of the memory blocks in the exchange heap because each block is owned by—at most—one process at any time. The fact that each block in the exchange heap is accessible by a single process at any time also provides a useful mutual exclusion guarantee.

Channels

With the IPC architecture 200, a channel is bi-directional message conduit consisting of exactly two endpoints. The endpoints are sometimes called the channel peers. A channel delivers messages loss-lessly and in order. Also, the messages are typically retrieved in the order they were sent. Semantically, each endpoint has a receive queue, and sending on an endpoint enqueues a message on the peer's queue.

Channels are described by channel contracts. In other words, the contract of each channel specifies the inter-process communications restrictions over that channel. For example, the contract may specify with which other processes that a process may communicate and how such communication may occur. The two ends of a channel are typically not symmetric. For descriptive purposes herein, one endpoint is called the importing end (Imp) and the other the exporting end (Exp). They are distinguished at the type level with types C.Imp and C.Exp respectively, where C is the channel contract governing the interaction.

FIG. 2 metaphorically illustrates channels as electrical plugs, cords, and outlets. In at least one described implementation, channels have exactly and only two endpoints and each endpoint is owed by, at most, one process. As depicted, channel 260 links process 230 and OS kernel 220 and has only two endpoints 262 and 264. Channel 270 links process 240 and process 250 and has only two endpoints 272 and 274. Channel 280 is a newly formed channel that initially links process 250 to itself, but still only has two endpoints 282 and 284.

These channels are represented by a graphic metaphor of an “electrical cord” with exactly two “plugs” (representing the endpoints). Rather than conducting electricity, these “cords” conduct messages being sent and received by each participant (“bi-directionally”) where the “cord” is plugged in. This bidirectional message passing is illustrated by the directional envelopes next to channel 270.

The IPC architecture 200 offers a message-passing IPC communication mechanism. Instead of using timely writing and reading of some shared memory (as in some of the conventional approaches), IPC architecture 200 limits inter-process communications to sending and receiving of messages.

Conventional OS message-passing approaches are one-way mechanisms-often with either one sender and multiple recipients or multiple senders and a one recipient. Unlike those conventional approaches, the channels of the IPC architecture 200 are two-way mechanisms with exactly two endpoints and at most two participants.

This is illustrated by channel 260 and channel 270 in FIG. 2. Channel 260 links process 230 and OS kernel 220 and only those two. Channel 270 links process 240 and process 250 and only those two.

As illustrated in FIG. 2, each of the bidirectional IPC channel has exactly two channel endpoints. Each channel endpoint is owned by, at most, one process at a time. For example, one channel endpoint is owned by one process and the other channel endpoint is owed by another process or is owned by the kernel of the operating system. Endpoints may be transferred over channels. In so doing, the ownership of those endpoints is transferred.

The IPC facilitator 222 guarantees that each message and each message's encapsulation are owned by at most one process at any instant. This may be accomplished by employing a channel-level abstraction for each channel. Furthermore, at the abstraction level of channels, a message resides in the accessible memory of, at most, one process at any instant. From the perspective of the communicating processes, the state contained within or accessible from a message is never shared. In at least one described implementation, a message is accessible by the message creator only until it is sent. In at least one described implementation, a message is accessible by the message recipient only after it is received.

Ownership

Memory isolation of endpoints and other data transferred on channels is guaranteed by tracking at compile time all blocks in the exchange heap. In particular, the static checks enforce that access to these resources occur at program points where the resource is owned and that methods do not leak ownership of the resources. Tracked resources have a strict ownership model.

Each resource is owned by at most one process at any point in time. For example, if an endpoint is sent in a message from thread T1 to thread T2, then ownership of the endpoint changes: from T1 to the message and then to T2, upon message's receipt.

In conventional approaches, a process makes a copy of data and passing that data along. Consequently, that data is now owned by multiple processes. The process that sent the data can still act on its copy of the data.

With at least one described implementation, ownership of data is linked to specific SIPs. The ownership of the data is passed along with the data being passed. Therefore, the sending SIP cannot act on the data once it has passed since it no longer has access to it and did not make a copy of it. In one or more implementations described herein, data is owned by one SIP and its ownership is passed along with the data once it is sent over a channel.

Similarly, each endpoint of a channel is owed by just one SIP. Ownership of an endpoint passes with the transfer of an endpoint to another SIP. Once it is sent, a sending SIP no longer has access to the endpoint of channel that it just sent.

This ownership transfer (of endpoints and data) is accomplished via an exchange heap, such as the exchange heap 132 shown in FIG. 1 or the exchange heap 290 shown in FIG. 2. More specifically, a memory block in the exchange heap contains a pointer (to either the memory location of subject data or a subject endpoint). When exchanging with another process across a channel, the sending process passes along the pointer to the memory block in the exchange heap to the receiving process.

In this manner, the sending process effectively passes along the subject data to the receiving process, but does so without making or retaining a copy for itself. Furthermore, the sending process effectively passes along ownership of the subject endpoint to the receiving process, without retaining ownership. Ownership transfer may also be described as the message's sender passing ownership by storing a pointer to the message in the receiver's endpoint, at a location determined by the current state of the message exchange protocol.

These exchanges where no data is copied may be called a “zero copy” approach. Using such an approach, disk buffers and network packets can be transferred across multiple channels, through a protocol stack and into an application process, without copying or any retention of the send data.

Channel Contracts

Channel contracts are employed by implementations described herein in order to facilitate the process isolation architecture. Channel contracts (and other aspects of inter-process communication) are also described in “Inter-Process Communications Employing Bi-directional Message Conduits” (referenced above).

Here's an example contract describing a simple interaction on a channel:

contract C1 {

in message Request(int x) requires x>0;
out message Reply(int y);
out message Error( );
state Start: Request?

−> (Reply! or Error!)
−> Start;

}

In this example, Contract C1 declares three messages: Request, Reply, and Error. Each message declaration specifies the types of arguments contained in the message. For example, Request and Reply both contain a single integer value, whereas Error does not carry any values. Additionally, each message may specify Spec# requires clauses restricting the arguments further.

Messages can also be tagged with a direction. The contract is written from the exporter point of view. Thus, in the example, Request is a message that can be sent by the importer to the exporter, whereas Reply and Error are sent from the exporter to the importer. Without a qualifier, messages can travel in both directions.

After the message declarations, a contract specifies the allowable message interactions via a state machine driven by send and receive actions. The first state declared is considered the initial state of the interaction. The example contract C1 declares a single state called Start. After the state name, action Request indicates that in the Start state, the export side of the channel is willing to receive a Request message. Following that the construct (Reply! or Error!) specifies that the exporter sends (!) either a Reply or an Error message. The last part (->Start) specifies that the interaction then continues to the Start state, thereby looping ad-infinitum.

A slightly more involved example is a portion of the contract for the network stack:

public contract TcpConnectionContract {

// Requests
in message Connect(uint dstIP,

ushort dstPort);

out message Ready( );
// Initial state
state Start : Ready! −> ReadyState;
state ReadyState : one {

Connect? −> ConnectResult;
BindLocalEndPoint? −> BindResult;
Close? −> Closed;

}
// Binding to a local endpoint
state BindResult : one {

OK! −> Bound;
InvalidEndPoint! −> ReadyState;

}
in message Listen( );
state Bound : one {

Listen? −> ListenResult;
Connect? −> ConnectResult;
Close? −> Closed;

}

...

The protocol specification in a contract serves several purposes. It can help detect programming errors, either at run-time or through a static analysis tool. Run-time monitoring drives a contract's state machine in response to the messages exchanged over a channel and watches for erroneous transitions. By itself, the run-time monitoring technique detects errors in one program execution, but it cannot detect “liveness” errors such as a non-termination. Liveness properties are properties of the form “something good happens eventually”, e.g., “eventually the program sends a message”. Static program analysis can provide a stronger guarantee that processes are correct and stuck-free in all program executions. In general, static analysis is not limited to monitoring one execution as it happens. It may, for example, rely on examining the instructions on the process in order to determine whether or not the process will eventually do something. There are fundamental results in logic that say that this will not always work, but it can work well enough in many cases.

One implementation uses a combination of run-time monitoring and static verification. All messages on a channel are checked against the channel's contract, which detects correctness, but not liveness problems. An implementation described herein has a static checker that verifies safety properties.

In addition, a compiler uses a contract to determine the maximum number of messages that can be outstanding on a channel, which enables the compiler to statically allocate buffers in the channel endpoints. Statically allocated buffers improve communication performance.

Endpoints

Channels are manifested as a pair of endpoints representing the importing and exporting sides of the channel. Each endpoint has a type that specifies which contract the channel adheres to. Endpoint types are implicitly declared within each contract. A contract Cl is represented as a class, and the endpoint types are nested types within that class as follows:
C1.Imp—Type of import endpoints of channels with contract C1.
C1.Exp—Type of export endpoints of channels with contract C1.
   Send/Receive Methods

Each contract class contains methods for sending and receiving the messages declared in the contract. The example provides the following methods:

C1.Imp {

void SendRequest(int x);
void RecvReply(out int y) ;
void RecvError( );

}
C1.Exp {

void RecvRequest(out int x)
void SendReply(int y);
void SendError( );

}

The semantics of the Send methods are that they send the message asynchronously. The receive methods block until the given message arrives. If a different message arrives first, an error occurs. Such errors should never occur if the program passes the contract verification check. Unless a receiver knows exactly which message it requires next, these methods are not appropriate.

Methodological Implementations

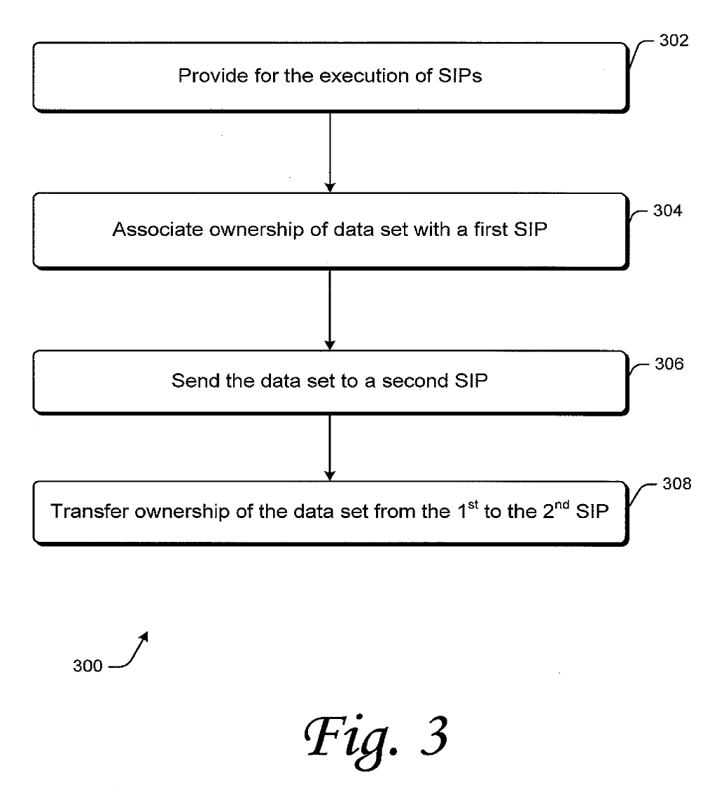

FIG. 3 shows methods 300 and 400 for facilitating effective inter-processing communication for statically verifiable SIPs. These methods 300 and 400 are performed by the one or more of the various components as depicted in FIGS. 1 and 2. Furthermore, these methods 300 and 400 may be performed in software, hardware, firmware, or a combination thereof.

At block 302 of FIG. 3, the operating system (OS) provides for the execution of one or more software isolation processes (SIPs) in a computer operating system environment.

At block 304, the OS associates ownership of particular data set with a first SIP. This data set may he a memory block in an exchange heap, such as the exchange heap 132 shown in FIG. 1 or the exchange heap 290 shown in FIG. 2. This data set may be a message. This data set may include data or one or more pointers to memory locations containing data. Also, this data set may include one or more pointers to channel endpoints.

At block 306, the OS sends the particular data set from the first SIP to a second SIP. The sending here may consist of providing a pointer to the data set (in the exchange heap) to the second SIP. Alternatively, the sending may consist of writing a message to the endpoint of a channel connected to the second SIP.

At block 308, the OS transfers ownership of the particular data set from the first SIP to the second SIP. When a message is sent over a channel, ownership passes from the sending SIP to the receiving SIP. The sending SIP no longer retains a reference to the message. In effect, the sending SIP no longer has access to the sent message.

During the sending 306 and the transferring 308, no copy of the sent information is retained. Indeed, no copy of the send information is created. Since just the pointer to the data set (or more precisely, a pointer to the memory block storing the data or pointer) is passed along, no copy is created and sent.

This ownership invariant is enforced by the programming tools and operating system (such as programming tools 160 and OS 100). This ownership invariant serves at least three purposes: The first is to prevent sharing between processes. The second is to facilitate static program analysis by eliminating pointer aliasing of messages. The third is to permit implementation flexibility by providing message-passing semantics that can be implemented by copying or pointer passing.

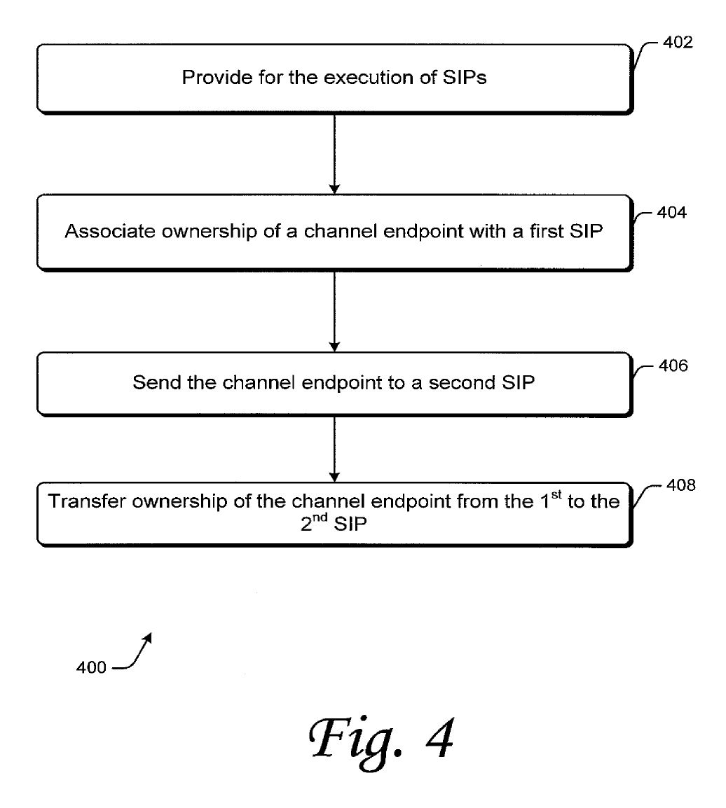

As depicted in FIG. 4, at 402, the operating system provides for the execution of one or more software isolation processes (SIPs) in a computer operating system environment.

At block 404, the OS associates ownership of a particular endpoint of a particular inter-process communications channel with a first SIP. This data set may be a memory block in an exchange heap, such as the exchange heap 132 shown in FIG. 1 or the exchange heap 290 shown in FIG. 2. This data set may be a message. This data set may include one or more pointers. The data set may include one or more pointers to memory locations containing one or more pointers. Also, this data set may include one or more pointers to channel endpoints.

At block 406, the OS sends the particular endpoint of the particular inter-process communications channel from the first SIP to a second SIP. The sending here may consist of providing a pointer to the particular endpoint (in the exchange heap) to the second SIP. Alternatively, the sending may consist of writing a message to the endpoint of a channel connected to the second SIP.

At block 408, the OS transfers ownership of the particular endpoint of the particular inter-process communications channel from the first SIP to the second SIP. When the endpoint ownership passes from the sending SIP to the receiving SIP, the sending SIP no longer retains a reference to the message. In effect, the sending SIP no longer has access to the sent data.

Furthermore, this transfer of endpoint-ownership occurs without creating and passing along a “copy.” Since just the pointer to the endpoint (or a pointer to the memory block storing the pointer to the endpoint) is passed along, no copy is created and sent.

Verification

The programming tools 160 may verity the programming of one or more SIPs. The programming tools 160 verify that code executed is type safe and enforcement of using of the strong invariants by the compiler and at runtime. Such strong invariants include (by way of example and not limitation):
Each block in the exchange heap has at most one owning thread (i.e., process) at any point in time.
Blocks in the exchange heap are only accessed by the owner of that block. Thus no access after a block is freed or a transfer of ownership.
Enforcement of channel contracts which define and restrict communication amongst processes (e.g., the sequence of messages observed on a channel correspond to the channel contract).
   Methodological Implementation of Verification

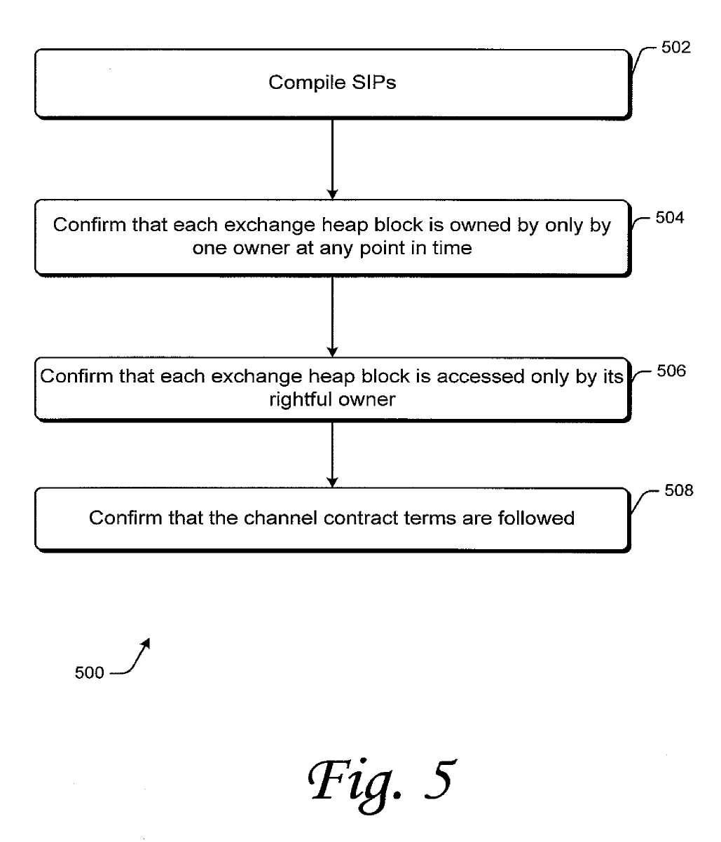

FIG. 5 shows method 500 for verification of isolated processes. This method 500 is performed by the one or more of the various components as depicted in FIGS. 1 and 2. Furthermore, this method 500 may be performed in software, hardware, firmware, or a combination thereof.

At block 502 of FIG. 5, compile executable code for one or more software isolation processes (SIPs) in a computer operating system environment that supports SIPs.

At block 504, during the compile time, the programming tools 160 confirms that each memory block in the exchange heap has-at most-one owning process at any point in time. This means that only one SIP will own any particular memory block at any one moment.

At block 506, during the compile time, the programming tools 160 confirms that each memory block in the exchange heap are only accessed by their rightful owner (e.g., SIP).

At block 508, during the compile time, the programming tools 160 confirms that the channel contracts terms are followed. For example, the tools confirm that the sequence of messages defined in the control is observed.

The programming tools 160 may report the results of such confirmations to a user, a program module, and/or the operating system. The programming tools 160 may perform its verification during compilation. In addition, it may also verify these same properties on the generated intermediate-language code. Furthermore, the programming tools 160 may verify a resulting form of typed assembly language yet again.

Conclusion

The techniques, described herein, may be implemented in many ways, including (but not limited to) program modules, general- and special-purpose computing systems, network servers and equipment, dedicated electronics and hardware, firmware, as part of one or more computer networks, or a combination thereof

One or more implementations described herein may be implemented via many well-known computing systems, environments, and/or configurations that arc, suitable for use include, but are not limited to, personal computers (PCs), server computers, hand-held or laptop devices, multiprocessor systems, microprocessor-based systems, programmable consumer electronics, wireless phones and equipments, general- and special-purpose appliances, application-specific integrated circuits (ASICs), network PCs, thin clients, thick clients, set-top boxes, minicomputers, mainframe computers, distributed computing environments that include any of the above systems or devices, and the like.

Although the one or more above-described implementations have been described in language specific to structural features and/or methodological steps, it is to be understood that other implementations may be practiced without the specific exemplary features or steps described herein. Rather, the specific exemplary features and steps are disclosed as preferred forms of one or more implementations. In some instances, well-known features may have been omitted or simplified to clarify the description of the exemplary implementations. Furthermore, for ease of understanding, certain method steps are delineated as separate steps; however, these separately delineated steps should not be construed as necessarily order dependent in their performance.

1. One or more processor-readable media having processor-executable instructions that, when executed by a processor, perform a method comprising:
associating ownership of a particular data set with a first process;
sending the particular data set from the first process to a second process;
transferring ownership of the particular data set from the first process to the second process, wherein the first process no longer has access to the particular data set after the transferring.

2. One or more media as recited in claim 1, wherein the data set includes a message.

3. One or more media as recited in claim 1, wherein the data set includes an endpoint of one or more inter-process communication.

4. One or more media as recited in claim 1, wherein the transferring of ownership occurs through one or more inter-process communication conduits connecting the first process and second process.

5. One or more media as recited in claim 1, wherein both the sending and the transferring are performed without memory allocation.

6. One or more media as recited in claim 1, wherein the data set is stored in an addressable location in allocated memory, the allocated memory having multiple addressable locations, each location being accessible by either the first or the second processes, but not both simultaneously.

7. An operating system comprising one or more media as recited in claim 1.

8. One or more processor-readable media having processor-executable instructions that, when executed by a processor, perform a method comprising:
providing for the execution of one or more isolated software processes in a computer operating system environment, wherein the transferring of ownership occurs through one or more inter-process communication channels, wherein each inter-process communications channel consists of two or more of endpoints;
sending a particular data set from the first process to the second process via the inter-process communication channel;
transferring ownership of the particular data set owned by the first isolated software process from the first isolated software process to the second isolated software process.

9. One or more media as recited in claim 8, wherein the first software process no longer has access to the particular data set after the transferring.

10. One or more media as recited in claim 8, wherein the first software process retains no copy of the particular data set after the transferring.

11. One or more media as recited in claim 8, wherein the data set includes one or more endpoints of other inter-process communication channels.

12. One or more media as recited in claim 8, wherein the sending and the transferring comprises writing a pointer into a particular buffer location in the receiving endpoint, wherein the pointer represents the data set being transmitted.

13. One or more media as recited in claim 8, wherein both the sending and the transferring are performed without memory allocation.

14. One or more media as recited in claim 8, wherein the particular data set is stored in an addressable location in a buffer, the buffer having multiple addressable locations, each location being accessible by either the first or the second isolated software processes, but not both simultaneously.

15. An operating system comprising one or more media as recited in claim 8.

16. One or more media as recited in claim 8, wherein the method further comprises:
determining whether the first isolated software process attempts to access an endpoint that that the first isolated software process does not own;
responsive to the determining, terminating the execution of the first process if the first process attempts to access an endpoint that that it does not own;
determining whether the second isolated process attempts to access an endpoint that that the second isolated process does not own;
responsive to the determining, terminating the execution of the second isolated process if the second isolated process attempts to access an endpoint that that it does not own.

17. One or more processor-readable media having processor-executable instructions that, when executed by a processor, perform a method comprising:
obtaining one or more isolated software processes on a computer operating system environment, wherein the obtained two or more isolated software processes are formatted to be executable on the computer operating system environment;
confirming that no memory block of a shared exchange heap is simultaneously accessible by more than one isolated software process, wherein such access would occur while the two or more isolated software processes are executing, the shared exchange heap having one or more memory blocks and one or more of the one or more memory blocks are accessible simultaneously to the two or more isolated software processes when the processes are executed.

18. One or more media as recited in claim 17, the method further comprising confirming that access to each of the one or more memory blocks of the shared exchange buffer is restricted to just the owner of the memory block being accessed.

19. One or more media as recited in claim 17, wherein the one or more isolated software processes software processes are Software Isolated Processes (SIPs) configured for inter-process communication via one or more channels, wherein each channel consists of two or more endpoints and inter-process communication over a channel is defined and restricted by a channel contract associated with each channel, the method further comprising confirming at runtime that inter-process communication via each channel connecting executable isolated software processes conforms with the definitions and restrictions specified in the channel contracts associated with each channel.

20. One or more media as recited in claim 17, wherein the one or more isolated software processes are Software Isolated Processes (SIPs) configured for inter-process communication via one or more channels, wherein each channel consists of two or more endpoints and inter-process communication over a channel is defined and restricted by a channel contract associated with each channel, the method further comprising confirming prior to execution of a process, via the means of a static analysis, that the process' inter-process communication via each channel connecting executable isolated software processes conforms with the definitions and restrictions specified in the channel contracts associated with each channel.

21. One or more media as recited in claim 17, the method further comprising:
associating ownership of a particular data set with a first executable isolated software process;
sending the particular data set from the first executable isolated software process to a second executable isolated software process;
transferring ownership of the particular data set from the first executable isolated software process to the second executable isolated software process.

22. One or more media as recited in claim 17, the method further comprising:
prior to execution of executable instructions of one or more isolated software processes, determining whether the one or more isolated software processes will attempt to access buffers or endpoints during execution that the attempting process does not own;
responsive to the determining, presenting an indication whether the one or more isolated software processes will attempt to access buffers or endpoints during execution that the attempting process does not own.
